(19) United States
(12) Patent Application Publication
(10) Pub. No.: US 2008/0053401 A1
(43) Pub. Date: Mar. 6, 2008

(54) Throttle device

(75) Inventors: Masanobu Kondo, Nagoya-shi (JP); Akihiro Kamiya, Takahama-shi (JP); Tsutomu Miyazaki, Nishikamo-gun (JP)

Correspondence Address: OLIFF & BERRIDGE, PLC, P.O. BOX 320850, ALEXANDRIA, VA, 22320-4850, US

(73) Assignees: AISAN KOGYO KABUSHIKI KAISHA, Obu-Shi (JP); TOYOTA JIDOSHA KABUSHIKI KAISHA, Toyota-Shi (JP)

(21) Appl. No.: 11/896,055

(22) Filed: Aug. 29, 2007

(30) Foreign Application Priority Data
Sep. 5, 2006 (JP) 2006-240046

(51) Int. Cl. F02D 9/08

(52) U.S. Cl. 123/337

(57) ABSTRACT

A throttle device includes a resin throttle body having a bore and a throttle valve placed in the throttle body to open and close the bore. The throttle body is formed of a valve part that includes the throttle valve and a duct part that does not include the throttle valve. The valve part and the duct part are formed separately and coupled to each other. A heater and a metal collar are attached to the valve part and the duct part.

### BACKGROUND OF THE INVENTION

1. Field of the Invention

The present invention relates to a throttle device to be placed in an intake passage of an engine.

2. Description of Related Art

Heretofore, an apparatus of this type has been known as an intake control apparatus for internal combustion engine disclosed in for example Jpn. unexamined utility model application publication No. 3(1991)-17242. This apparatus includes a resin throttle body, a throttle valve for opening and closing a-bore of the throttle body, and a heater embedded in the throttle body near an inner wall surface of the bore to heat the throttle valve and its surrounding area.

In the above apparatus disclosed in the publication '242, however, the heater is embedded in the throttle body and therefore the apparatus could only be produced in a configuration having the throttle body originally equipped with a heater. If the apparatus needs to have a throttle body without heater, such throttle body without heater has to be produced additionally. In other words, when the throttle body without heater is required, the throttle body without heater has to be produced in addition to the throttle body with heater. Thus causes an increase in the number of designing processes of the apparatus and besides requires a variety of molding dies and an increase in the number of such dies, resulting in a high production cost of the entire apparatus.

### SUMMARY OF THE INVENTION

The present invention has been made in view of the above circumstances and has an object to provide a throttle device which can be produced as either of a throttle device with heater and a throttle device without heater according to whether or not a heater is required.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a throttle device comprising: a resin throttle body having a bore; a throttle valve placed in the throttle body to open and close the bore, the throttle body including a valve part in which the throttle valve is placed and a duct part formed separately from the valve part and coupled to the valve part; and a heater attached to at least one of the valve part and the duct part.

### BRIEF DESCRIPTION OF THE DRAWINGS

FIG. 1 is a sectional view of a throttle device with heater in a first embodiment;

FIG. 2 is a sectional view of part of the throttle device with heater in the first embodiment;

FIG. 3 is an exploded sectional view of the throttle device with heater in the first embodiment;

FIG. 4 is a sectional view of a throttle device without heater in the first embodiment;

FIG. 5 is an exploded sectional view of a throttle device with heater in a second embodiment;

FIG. 6 is a sectional view of part of a throttle device with heater in a third embodiment;

FIG. 7 is a sectional view of part of a throttle device with heater in a fourth embodiment;

FIG. 8 is a sectional view of part of a throttle device with heater in a fifth embodiment;

FIG. 9 is a sectional view of part of a throttle device with heater in a sixth embodiment;

FIG. 10 is a sectional view of part of a throttle device with heater in a seventh embodiment;

FIG. 11 is a sectional view of part of a throttle device with heater in a eighth embodiment;

FIG. 12 is a sectional view of part of a throttle device with heater in a ninth embodiment; and

FIG. 13 is a sectional view of part of a throttle device with heater in a tenth embodiment.

### DETAILED DESCRIPTION OF THE PREFERRED EMBODIMENTS

### First Embodiment

A detailed description of a first preferred embodiment of a throttle device embodying the present invention will now be given referring to the accompanying drawings.

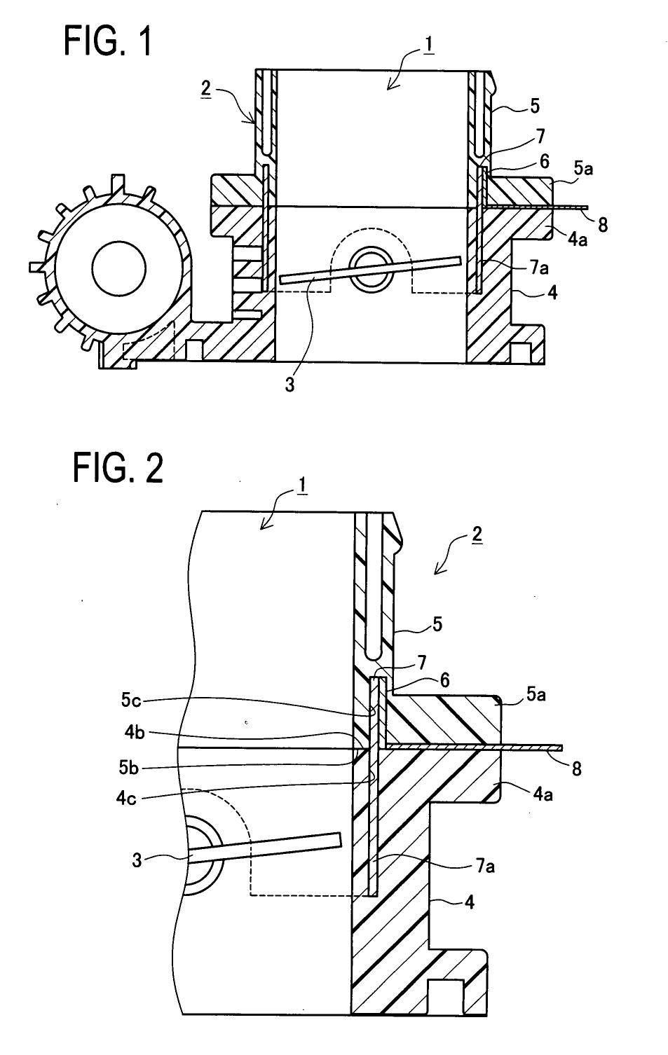

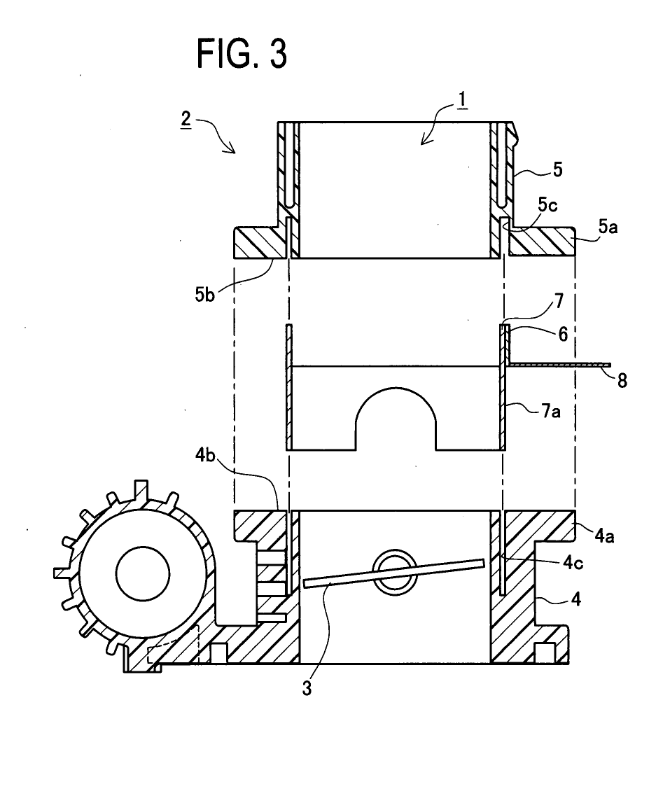

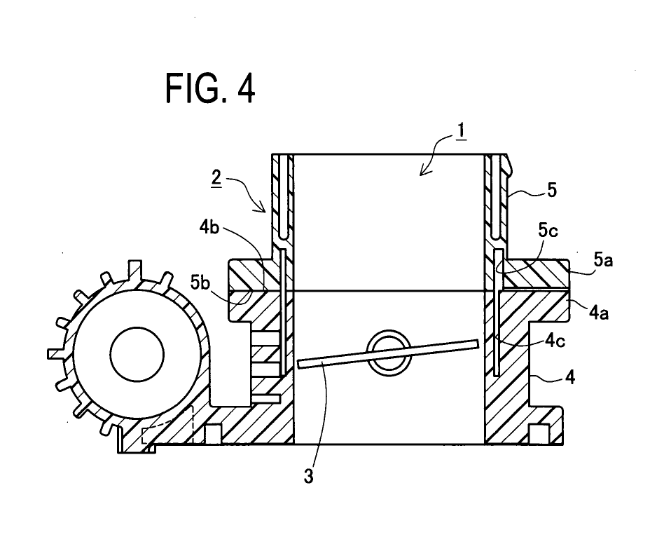

FIG. 1 is a sectional view of a throttle device with heater (hereinafter, referred to as a “heater-equipped throttle device”). FIG. 2 is a sectional view of part of the heater-equipped throttle device. FIG. 3 is an exploded sectional view of the heater-equipped throttle device. FIG. 4 is a sectional view of a throttle device without heater (hereinafter, referred to as a “heaterless throttle device”).

As shown in FIG. 1, this throttle device includes a resin throttle body 2 having a bore 1 and a throttle valve 3 provided in the throttle body 2 to open and close the bore 1. The throttle valve 3 is operated to open and close by a driving mechanism not shown. This throttle device can be installed in an intake passage of an engine to control an amount of intake air to the engine. In the present embodiment, a resin material for the throttle body 2 may include a polyphenylene sulfide (PPS) resin, for example.

As shown in FIGS. 1 to 3, the resin throttle body 2 is formed of separate components, i.e., a valve part 4 that includes a throttle valve 3 and a duct part 5 that does not includes the throttle valve 3. The valve part 4 and the duct part 5 are provided with a flange 4a and a flange 5a respectively and are adhesively coupled to each other through the flanges 4a and 5a. Specifically, the valve part 4 and the duct part 5 are configured to be coupled to each other by adhesively connecting of the flanges 4a and 5a. It is to be noted that adhesive connection of the flanges 4a and 5a may be conducted by appropriately using connecting manners such as adhesive, welding, and so on. A cylindrical heater 6 and a cylindrical metal collar 7 are attached to the duct part 5. Correspondingly, the duct part 5 is formed, on a connected surface 5b, with a circumferential groove 5c for allowing attaching of the heater 6 and the metal collar 7. To be specific, the metal collar 7 and the heater 6 are fixedly inserted in the circumferential groove 5c. The heater 6 is attached to the outer periphery of the metal collar 7 in the circumferential groove 5c so that the heater 6 is placed upstream from the throttle valve 3. A lower half, skirt portion 7a of the metal collar 7 protrudes from the duct part 5. On the other hand, the valve part 4 is formed, on a connected surface 4b, with a circumferential groove 4c which is axially aligned with the circumferential groove 5c of the duct part 5. The skirt portion 7a of the metal collar 7 is configured to be insertable in the circumferential groove 4c. When fixed to the duct part 5, the metal collar 7 is placed around the throttle valve 3 as shown in FIG. 1. The metal collar 7 is made of aluminum, for example, corresponding to a heat conducting member of the present invention. The heater 6 used in the present embodiment is a PTC (positive temperature coefficient).

As shown in FIGS. 1 and 2, the heater 6 is provided with a lead wire 8 for electric supply arranged to extend from between the flanges 4a and 5a to the outside. When the heater 6 is energized through this lead wire 8, the heater 6 generates heat. The heat of the heater 6 is then conducted to the duct part 5 and the valve part 4 through the metal collar 7. When the duct part 5 and the valve part 4 are heated in this way, part of the bore 1 (i.e., part of the inner wall of the throttle body 2) around the throttle valve 3 is warmed. This warming is utilized to freeze-proof the throttle valve 3.

According to the structure of the throttle device in the present embodiment described above, the throttle body 2 is formed of the separate components, i.e., the valve part 4 that includes the throttle valve 3 and the duct part 5 that does not include the throttle valve 3. The valve part 4 and the duct part 5 are configured to be assembled to each other and to allow the heater 6 to be attached to the duct part 5 and the metal collar 7 to be attached to the duct part 5 and the valve part 4. By assembling the duct part 5 and the valve part 4 to each other and attaching the heater 6 and the metal collar 7 thereto, the heater-equipped throttle body 2 shown in FIG. 1 can be produced. Alternatively, by assembling the duct part 5 and the valve part 4 to each other without attaching the heater 6 and the metal collar 7 thereto, the heaterless throttle body 2 shown in FIG. 4 can be produced. Use of uniform duct parts 5 and uniform valve parts 4 is therefore allowed for production of either of the heater-equipped throttle body 2 and the heaterless throttle body 2. Thus, either of the heater-equipped throttle device shown in FIG. 1 and the heaterless throttle device shown in FIG. 4 can be produced with the uniform duct parts 5 and the uniform valve parts 4 depending on the necessity of the heater 6. Consequently, the above configuration can prevent the increase of the number of designing processes for the throttle device, the increase of the types and the number of molding dies. This allows a production cost of the entire throttle device to be reduced.

In the present embodiment, the metal collar 7 is provided in addition to the heater 6, so that the heat of the heater 6 is easily conducted to the valve part 4 through the metal collar 7. In this light, warming by the heater 6 can efficiently be achieved.

In the present embodiment, furthermore, the PTC heater is used for the heater 6 and thus the duct part 5 and the valve part 4 are heated relatively quickly. From this viewpoint, warming by the heater 6 can also efficiently be achieved.

In the present embodiment, the valve part 4 and the duct part 5 are adhesively coupled, so that both parts 4 and 5 can be assembled to each other relatively easily.

In the present embodiment, the collar 7 is made of metal having higher heat conductivity than the throttle body 2 to further facilitate heat conduction from the heater 6 to the resin throttle body 2. Also from this viewpoint, warming by the heater 6 can efficiently be achieved.

### Second Embodiment

Next, a second embodiment of the throttle device of the present invention will be described in detail, referring to the accompanying drawing. In each of the present and subsequent embodiments which will be explained below, identical parts or components to those in the first embodiment are given the same reference numbers and their explanations are omitted. The following explanations are made with a focus on differences from the first embodiment.

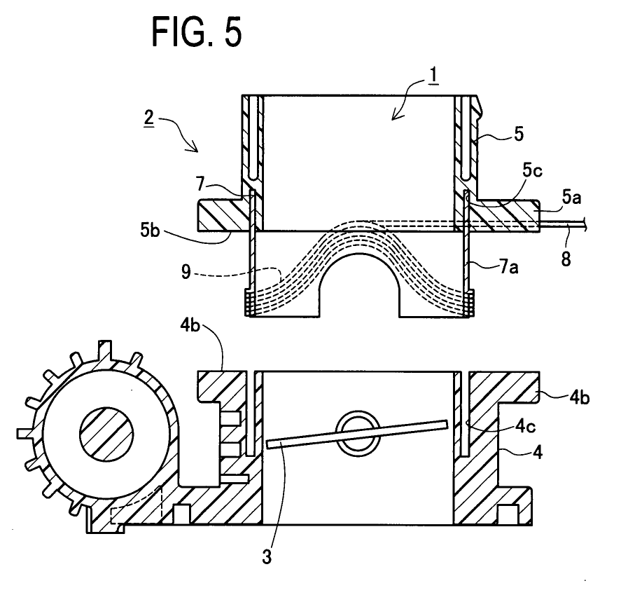

FIG. 5 is an exploded sectional view of a heater-equipped throttle device in the present embodiment. The present embodiment is mainly different in the configuration of a heater 9 from the first embodiment. The heater 9 in the present embodiment is a coil heater formed of electric resistance wire. This heater 9 is wound in a wavy shape around the periphery of the metal collar 7. The lead wire 8 of the heater 9 is arranged to extend from the flange 5a of the duct part 5 to the outside. Other structures in the present embodiment are basically identical to those in the first embodiment.

Accordingly, the present embodiment essentially produces functions and advantages similar to those in the first embodiment. In the present embodiment, the heater 9 is the coil heater formed of electric resistance wire and therefore its shape can be designed freely. Thus, the heater 9 is allowed to be arranged on the periphery of the metal collar 7 to widely extend over both the duct part 5 and the valve part 4. This contributes to enhancement of the warm-up efficiency of the heater 9.

### Third Embodiment

A third embodiment of the throttle device of the present invention will be explained below, referring to the accompanying drawing.

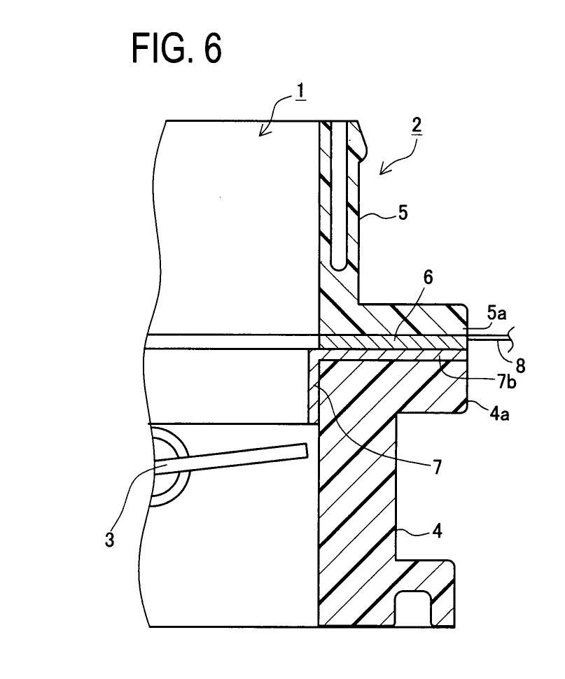

FIG. 6 is a sectional view of part of a heater-equipped throttle device in the present embodiment. The present embodiment is mainly different in the configurations of the heater 6 and the metal collar 7 from the first embodiment. In the present embodiment, the metal collar 7 having a flange 7b is fixed to the valve part 4 in such a manner as to be exposed along the inner wall surface of the bore 1. The flange 7b of the metal collar 7 is connected to the flange 4a of the valve part 4. In this state, the duct part 5 and the valve part 4 are coupled to each other with the annular heater 6 interposed between the flange 7b of the metal collar 7 and the flange 5a of the duct part 5.

Accordingly, the present embodiment essentially produces functions and advantages similar to those in the first embodiment. In the present embodiment, the metal collar 7 is arranged to be exposed along the inner wall surface of the bore 1. Thus, the inner wall of the bore 1 can be heated directly by the heat conducted from the heater 6 to the metal collar 7. In the present embodiment, furthermore, the duct part 5 and the valve part 4 do not need to be formed with the circumferential groove for attachment of the metal collar 7 and the heater 6.

### Fourth Embodiment

A fourth embodiment of the throttle device of the present invention will be explained below, referring to the accompanying drawing.

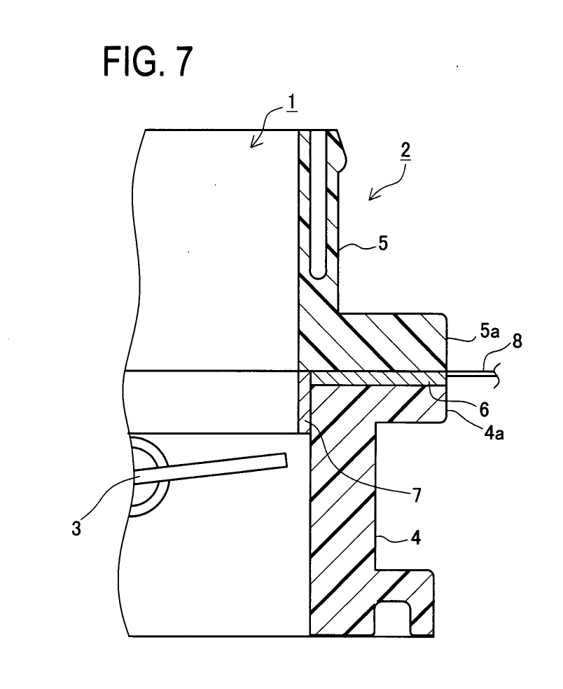

FIG. 7 is a sectional view of part of a heater-equipped throttle device in the present embodiment. The present embodiment is mainly different in the configurations of the heater 6 and the metal collar 7 from the third embodiment. In the present embodiment, the metal collar 7 having no flange is attached to the valve part 4 in such a manner as to be exposed along the inner wall surface of the bore 1. The duct part 5 and the valve part 4 are coupled to each other with the heater 6 annularly arranged in contact with the periphery of an end portion of the metal collar 7 and interposed between the flange 5a of the duct part 5 and the flange 4a of the valve part 4.

Accordingly, the present embodiment essentially produces functions and advantages similar to those in the third embodiment. The metal collar 7 can be produced in a simplified process because of the absence of flange.

### Fifth Embodiment

A fifth embodiment of the throttle device of the present invention will be explained below, referring to the accompanying drawing.

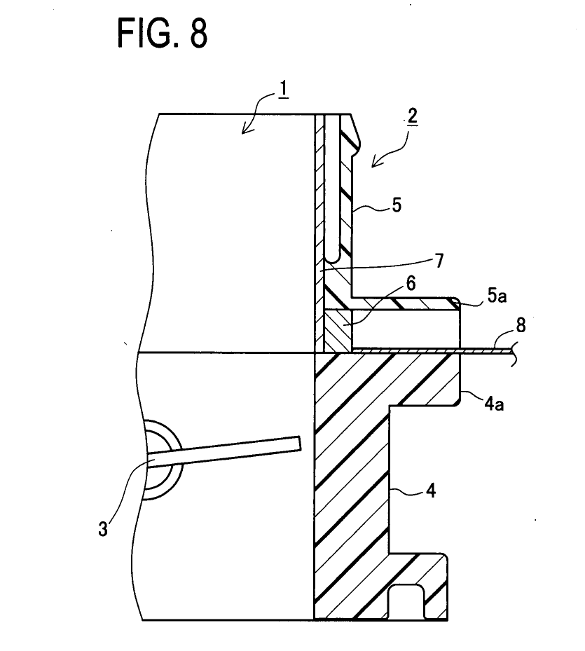

FIG. 8 is a sectional view of part of a heater-equipped throttle device in the present embodiment. The present embodiment is mainly different in the configurations of the heater 6 and the metal collar 7 from the fourth embodiment. In the present embodiment, the metal collar 7 without flange is attached to the duct part 5 in such a manner as to be exposed along the inner wall surface of the bore 1. In the present embodiment, particularly, the entire inner wall surface of the bore 1 in the duct part 5 is constituted of the metal collar 7. The duct part 5 and the valve part 4 are assembled to each other with the heater 6 placed in contact with the periphery of an end portion of the metal collar 7 and interposed between the flange 5a of the duct part 5 and the flange 4a of the valve part 4.

Accordingly, the present embodiment essentially produces functions and advantages similar to those in the fourth embodiment. The entire bore 1 of the duct part 5 can be heated directly by the heat of the heater 6 through the metal collar 7, thereby enhancing warm-up efficiency of the heater 6.

### Sixth Embodiment

A sixth embodiment of the throttle device of the present invention will be explained below, referring to the accompanying drawing.

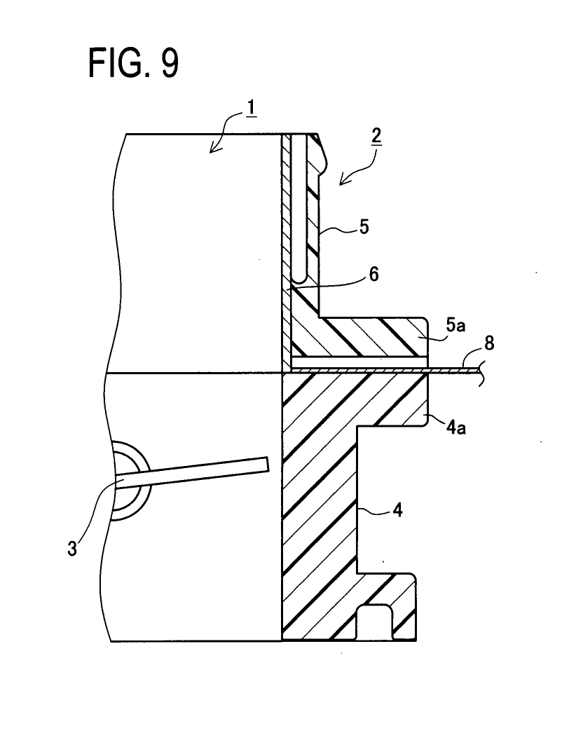

FIG. 9 is a sectional view of part of a heater-equipped throttle device in the present embodiment. The present embodiment is mainly different in the absence of metal collar from each of the aforementioned embodiments. In the present embodiment, to be concrete, the heater 6 is formed in a cylindrical shape and attached to the duct part 5 in such a manner as to be exposed along the inner wall surface of the bore 1. In the present embodiment, particularly, the entire inner wall surface of the bore 1 in the duct part 5 is constituted of the heater 6. The duct part 5 and the valve part 4 are assembled to each other with the lead wire 8 of the heater 6 arranged to extend outward through a clearance between the flange 5a of the duct part 5 and the flange 4a of the valve part 4.

Accordingly, the present embodiment essentially produces functions and advantages similar to those in the fifth embodiment. The entire bore 1 of the duct part 5 can be heated directly by the heater 6, further enhancing warm-up efficiency of the heater 6. In addition, the entire structure of the throttle device can be simplified because of the absence of metal collar.

### Seventh Embodiment

A seventh embodiment of the throttle device of the present invention will be explained below, referring to the accompanying drawing.

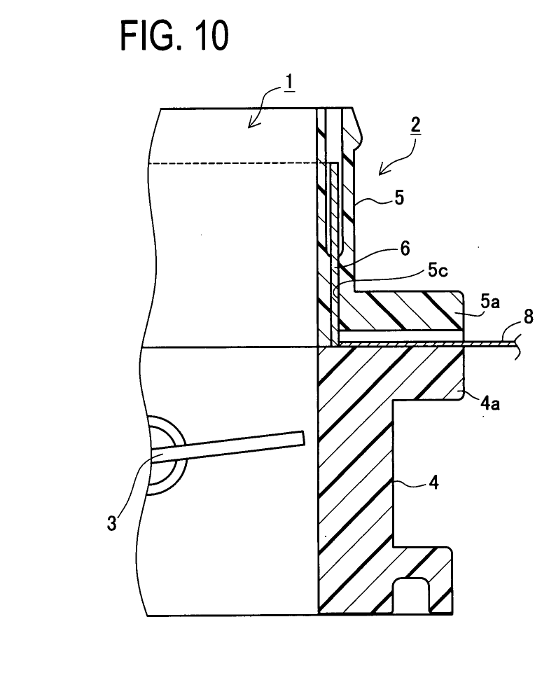

FIG. 10 is a sectional view of part of a heater-equipped throttle device in the present embodiment. The present embodiment is mainly different in the placement of the heater 6 from the sixth embodiment. In the present embodiment, the duct part 5 is formed in a double-walled structure having a circumferential groove 5c vertically extending through the cylindrical wall of the duct part 5 so that the cylindrical heater 6 is inserted in the circumferential groove 5c. The duct part 5 and the valve part 4 are assembled to each other with the lead wire 8 of the heater 6 arranged to extend outward through a clearance between the flange 5a of the duct part 5 and the flange 4a of the valve part 4.

Accordingly, the present embodiment essentially produces functions and advantages similar to those in the sixth embodiment. Since the entire heater 6 is held inside the duct part 5, the heater 6 can be protected from water or moisture.

### Eighth Embodiment

An eighth embodiment of the throttle device of the present invention will be explained below, referring to the accompanying drawing.

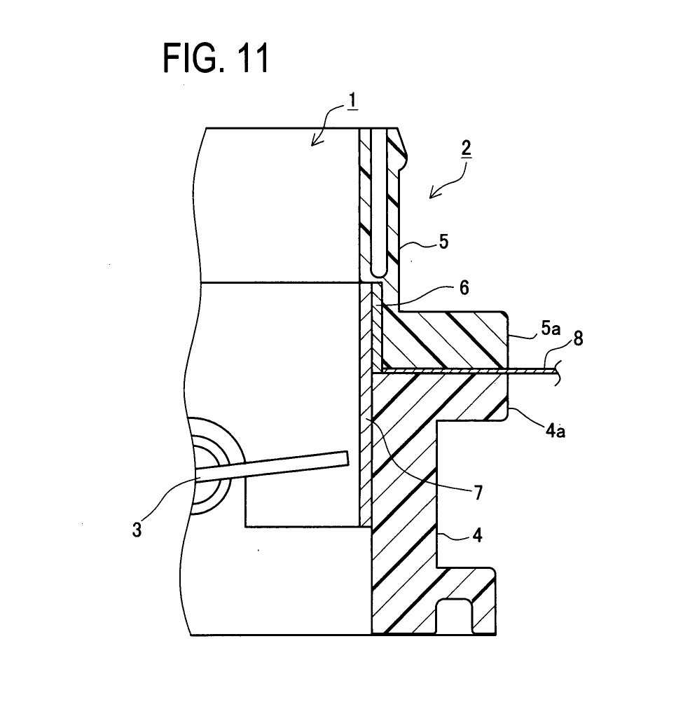

FIG. 11 is a sectional view of part of a heater-equipped throttle device in the present embodiment. The present embodiment is mainly different in the configurations of the heater 6 and the metal collar 7 from the fourth embodiment. In the present embodiment, the metal collar 7 having no flange is attached over the valve part 4 and the duct part 5 in such a manner as to be exposed along their inner walls of the bore 1. The duct part 5 and the valve part 4 are assembled to each other with the heater 6 placed in contact with the periphery of an end portion of the metal collar 7 and interposed between the duct part 5 and the metal collar 7.

The present embodiment essentially produces functions and advantages similar to those in the fourth embodiment. Owing to the metal collar 7 exposed along part of the inner wall surface of the bore 1 in both of the valve part 4 and the duct part 5, the heat of the heater 6 can be transferred over a wide area around the throttle valve 3.

### Ninth Embodiment

A ninth embodiment of the throttle device of the present invention will be explained below, referring to the accompanying drawing.

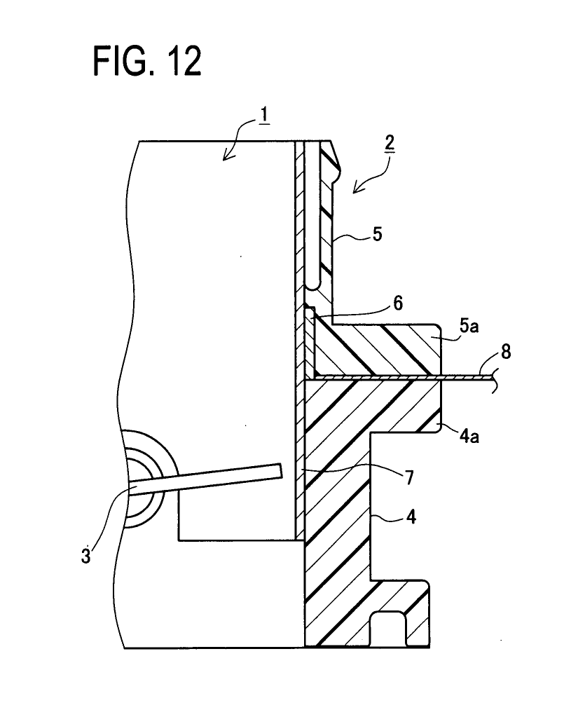

FIG. 12 is a sectional view of part of a heater-equipped throttle device in the present embodiment. The present embodiment is mainly different in the configuration of the metal collar 7 from the eighth embodiment. In the present embodiment, the metal collar 7 is attached over the valve part 4 and the duct part 5 in such a manner as to be exposed along the inner wall surface of the bore 1 in the duct part 5. In the present embodiment, particularly, the entire inner wall surface of the bore 1 in the duct part 5 is constituted of the metal collar 7. Thus, the duct part 5 and the valve part 4 are assembled to each other with the heater 6 placed in contact with the periphery of a center portion of the metal collar 7 and interposed between the duct part 5 and the metal collar 7.

Accordingly, the present embodiment essentially produces functions and advantages similar to those in the eighth embodiment. The entire bore 1 of the duct part 5 and the area around the throttle valve 3 can widely be heated directly by the heat of the heater 6 through the metal collar 7, thus enhancing warm-up efficiency of the heater 6.

### Tenth Embodiment

A tenth embodiment of the throttle device of the present invention will be explained below, referring to the accompanying drawing.

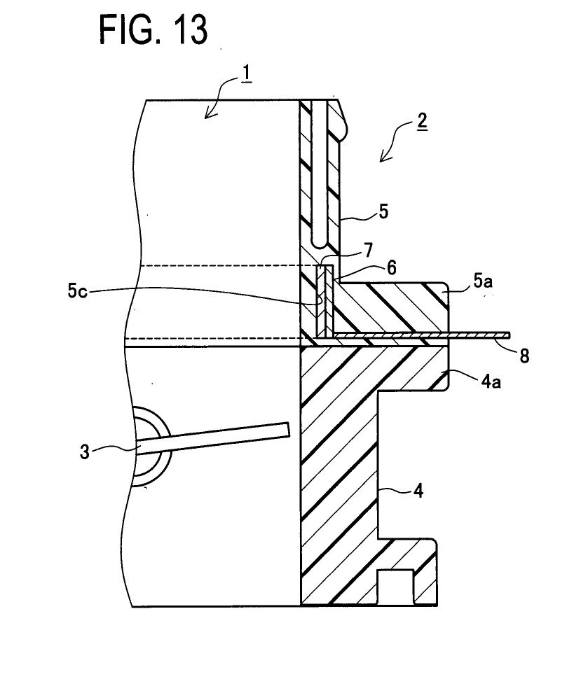

FIG. 13 is a sectional-view of part of a heater-equipped throttle device in the present embodiment. The present embodiment is mainly different in the configurations of the heater 6 and the metal collar 7 from the first embodiment. In the present embodiment, the heater 6, the metal collar 7, and the lead wire 8 are integrally placed inside the duct part 5 by insert molding. The metal collar 7 of a short cylindrical shape is embedded in a lower portion of the duct part 5. The heater 6 is embedded in contact with part of the periphery of the metal collar 7. Therefore, the lead wire 8 extending from the heater 6 is similarly embedded in the duct part 5. The duct part 5 and the valve part 4 are thus assembled to each other with the flanges 5a and 4a directly connected to each other.

Accordingly, the present embodiment essentially produces functions and advantages similar to those in the first embodiment. The heater 6, metal collar 7, and lead wire 8 are embedded in the duct part 5 by insert molding, so that those heater 6, metal collar 7, and lead wire 8 can be protected from water or moisture.

The present invention may be embodied in other specific forms without departing from the essential characteristics thereof.

For instance, the cylindrical PTC heater is used for the heater 6 in the first embodiment. As an alternative, a flat PTC heater may be used.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A throttle device comprising:
a resin throttle body having a bore;
a throttle valve placed in the throttle body to open and close the bore,
the throttle body including a valve part in which the throttle valve is placed and a duct part formed separately from the valve part and coupled to the valve part; and
a heater attached to at least one of the valve part and the duct part.

2. The throttle device according to claim 1 further including a heat conducting member for conducting heat of the heater to at least one of the valve part and the duct part.

3. The throttle device according to claim 1, wherein the heater is placed upstream from the throttle valve.

4. The throttle device according to claim 2, wherein the heater is placed upstream from the throttle valve.

5. The throttle device according to claim 1, wherein the heater is a PTC heater.

6. The throttle device according to claim 2, wherein the heater is a PTC heater.

7. The throttle device according to claim 3, wherein the heater is a PTC heater.

8. The throttle device according to claim 1, wherein the heater is an electric resistance wire.

9. The throttle device according to claim 2, wherein the heater is an electric resistance wire.

10. The throttle device according to claim 3, wherein the heater is an electric resistance wire.

11. The throttle device according to claim 1, wherein the heater is a cylindrical coil heater.

12. The throttle device according to claim 2, wherein the heater is a cylindrical coil heater.

13. The throttle device according to claim 3, wherein the heater is a cylindrical coil heater.

14. The throttle device according to claim 2, wherein the heat conducting member is made of a material having a higher heat conductivity than the throttle body.

15. The throttle device according to claim 1, wherein the valve part and the duct part are adhesively coupled to each other.

16. The throttle device according to claim 2, wherein the valve part and the duct part are adhesively coupled to each other.

17. The throttle device according to claim 3, wherein the valve part and the duct part are adhesively coupled to each other.

18. The throttle device according to claim 5, wherein the valve part and the duct part are adhesively coupled to each other.

19. The throttle device according to claim 8, wherein the valve part and the duct part are adhesively coupled to each other.

20. The throttle device according to claim 11, wherein the valve part and the duct part are adhesively coupled to each other.
